(19) United States
(12) Patent Application Publication
(10) Pub. No.: US 2009/0152376 A1
(43) Pub. Date: Jun. 18, 2009

(54) Fluid-handling device with multiple elastic bladders

(76) Inventor: Robert J. Harter, La Crosse, WI (US)

Correspondence Address: ROBERT J. HARTER, 4233 CLIFFSIDE DRIVE, LA CROSSE, WI, 54601, US

(21) Appl. No.: 12/288,876

(22) Filed: Oct. 24, 2008

Related U.S. Application Data
(60) Provisional application No. 61/007,285, filed on Dec. 12, 2007.

(51) Int. Cl. B05B 9/08; B05B 9/03; B05B 9/04

(52) U.S. Cl. 239/152; 239/322; 222/212; 239/154

(57) ABSTRACT

A fluid-handling device, such as a lawn-and-garden water sprayer, includes a plurality of elastic bladders that are filled via a common manifold. To ensure that all the bladders can be filled without one bladder over expanding or emptying into another one, the fluid-handling device includes a plurality of limit valves in one-to-one correspondence with the plurality of bladders. When filling the bladders, the limit valves are open to convey fluid from the manifold to the bladders. In some examples of the invention, each individual limit valve will close automatically in response to its respective bladder having reached a predetermined expanded length.

### CROSS-REFERENCE TO RELATED APPLICATIONS

This application claims the benefit of provisional patent application Ser. No. 61/007,285, filed Dec. 12, 2007 by the present inventor.

### FIELD OF THE INVENTION

The subject invention generally pertains to fluid-handling devices (e.g., water sprayers) and more specifically to a device that uses a resiliently expandable bladder.

### BACKGROUND OF RELATED ART

Various devices include resiliently expandable bladders for dispensing pressurized water. Examples of such devices are disclosed in U.S. Pat. Nos. 6,659,366; 5,174,477; 4,867,208; 4,735,239 and 3,848,808. These patents show and describe single-bladder devices with limited water-holding capacity.

Larger bladders can be used for holding greater volumes of water; however, for a given bladder wall thickness, larger diameter bladders tend to have less pressure containing capacity.

If multiple smaller diameter bladders were interconnected, another problem arises. When two elastic bladders, for instance, are connected to each other by a common conduit, often the less-filled bladder tends to empty into the one that is more full. If additional water is forced into the two bladders, the larger one might actually burst before the smaller one gets even close to being full.

### SUMMARY OF THE INVENTION

It is an object of some embodiments of the present invention to provide a fluid-handling device that includes a plurality of elastic bladders connected to a common manifold, wherein the fluid-handling device includes one or more limit valves that ensures that all the bladders can be filled without overfilling any of them.

Another object of some embodiments is to prevent the normal operating pressure of one bladder from precluding another bladder from reaching its initial bulge state.

Another object of some embodiments is to provide a backpack system that includes a plurality of elastic bladders for greater volume holding capacity for a given pressure.

Another object of some embodiments is to provide a multi-bladder system with a limit valve that can be used for both filling and discharging fluid.

Another object of some embodiments is to provide fluid-handling device that includes a resiliently expandable bladder with a limit valve that prevents the bladder from being overfilled. The limit valve is actuated by a pulling action, rather than a pushing action, so that the valve and actuator can be completely contained within the interior of the fluid-handling device rather than be exposed on the exterior of the device.

Another object of some embodiments is to limit the expansion of a resiliently expandable bladder that has a normal operating range of expansion (e.g., 20% to 50% of is maximum burst volume) wherein the normal operating pressure is substantially constant over that normal operating range, the normal operating range lies between an initial bulge pressure and a burst pressure, and the normal operating pressure is appreciably less than both the initial bulge pressure and the burst pressure.

Another object of some embodiments is to limit the expansion of a resiliently expandable bladder by actuating a valve in response to the bladder's change in axial length.

One or more of these and/or other objects of the invention are provided by a fluid-handling device that includes a plurality of elastic bladders that can be filled via a common manifold.

### BRIEF DESCRIPTION OF THE DRAWINGS

FIG. 1 is a schematic side view of one example of a fluid-handling device.

FIG. 2 is side view of the fluid-handling device of FIG. 1 but showing the device installed in a backpack.

FIG. 3 is a side view of the watering device's resiliently expandable bladder in a relaxed state.

FIG. 4 is a side view similar to FIG. 3 but showing the bladder expanding under an initial bulge pressure.

FIG. 5 is a side view similar to FIGS. 3 and 4 but showing the bladder beyond its initial bulge state.

FIG. 6 is a side view similar to FIGS. 3-5 but showing the bladder at a predetermined expanded state.

FIG. 7 is a side view similar to FIGS. 3-6 but showing the bladder at an over expanded state.

FIG. 8 is a graph showing the pressure/volume relationship of the bladder of FIGS. 3-7.

FIG. 9 is a cross-sectional side view of the fluid-handling device of FIG. 1.

FIG. 10 is a cross-sectional side view similar to FIG. 9 but showing an alternate fluid-handling device.

FIG. 11 is a schematic side view similar to FIG. 1 but showing another example of a fluid-handling device.

### DESCRIPTION OF THE PREFERRED EMBODIMENT

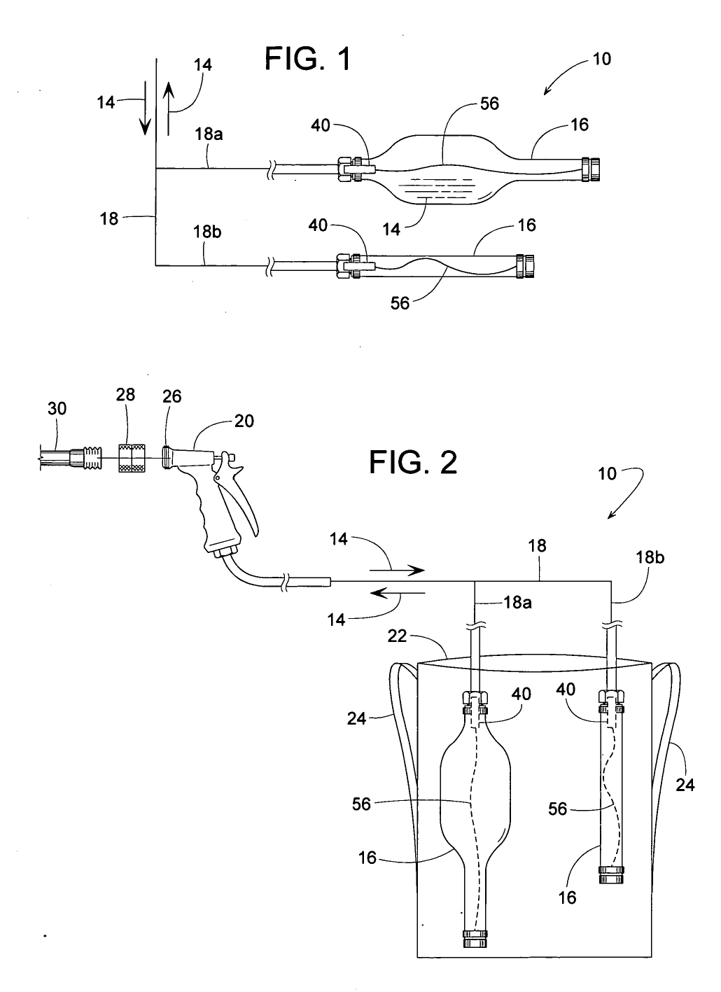

FIG. 1 is a schematic diagram showing one example of a fluid-handling device 10 (e.g., water and/or chemical sprayer) for discharging a fluid 14 under pressure. To store and later release fluid 14 under pressure, device 10 preferably includes at least two elastic bladders 16 that are resiliently expandable. To convey fluid 14 to and from bladders 16, device 10 also includes a manifold 18 connected in fluid communication with both bladders 16. Bladders 16 can expand resiliently upon receiving fluid 14 under pressure from a suitable source, such as, for example, water from a municipal water supply.

FIG. 2 shows device 10 connected to a conventional garden nozzle 20 with bladders 16 being installed within a backpack 22 that has two shoulder straps 24. In this particular example, nozzle 20 not only provides a way to spray fluid 14 discharged from within bladders 16, but nozzle 20 can be provided with a standard threaded garden hose end 26 that a standard female-to-female garden hose adaptor 28 can connect to a standard garden hose 30 for filling bladders 16.

Although bladders 16 can be of various shapes, sizes, construction, and materials, one example of bladder 16 is a latex rubber tube having a relaxed outside diameter of 0.875 inches, a relaxed inside diameter of 0.5 inches, and a relaxed length of 9 inches.

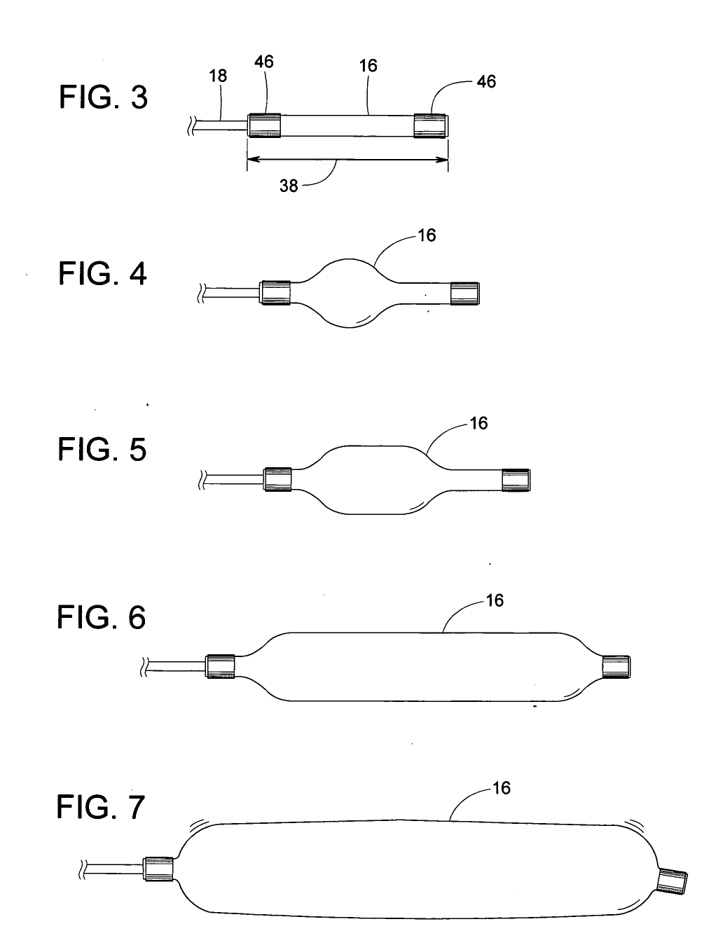

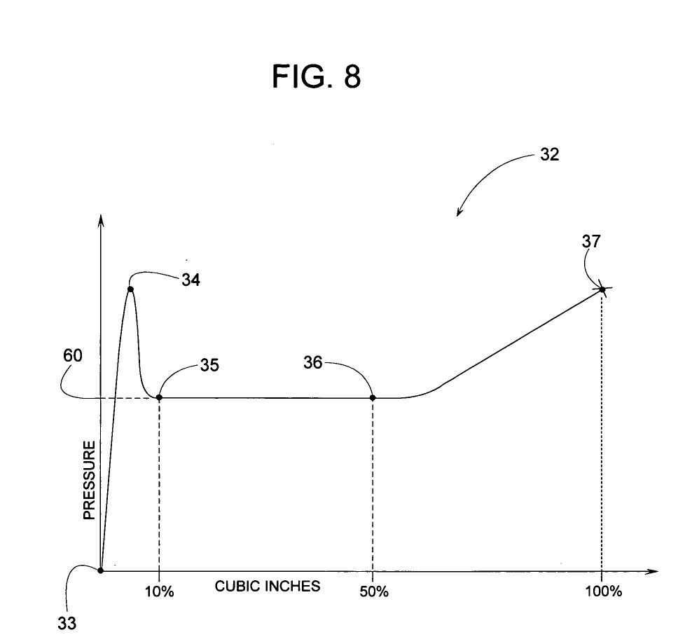

If a bladder 16 were unprotected from overfilling, bladder 16 could be expanded through the sequential steps shown in FIGS. 3-7. The sequence of expansion is also represented in graph 32 of FIG. 8, where points 33, 34, 35, 36 and 37 correspond to FIGS. 3, 4, 5, 6 and 7 respectively. FIG. 3 and point 33 of FIG. 8 represent bladder 16 being in a relaxed state with a minimum bladder length 38. FIG. 4 and point 34 represent bladder 16 initially bulging at an initial bulge pressure. For a latex tube having a relaxed OD of about 0.875 inches and a relaxed ID of about 0.5 inches, the initial bulge pressure is about 25 psig. FIG. 5 and point 35 represent bladder 16 expanding beyond the initial bulge of FIG. 4. FIG. 6 and point 36 represent bladder 16 expanding even farther. For bladder 16 with its given sample dimensions, the expansion from point 35 to point 36 occurs at about 15 psig (substantially constant pressure). FIG. 7 and point 37 of FIG. 8 represent bladder 16 expanding to its impending burst condition, which for this example occurs at about 25 psig.

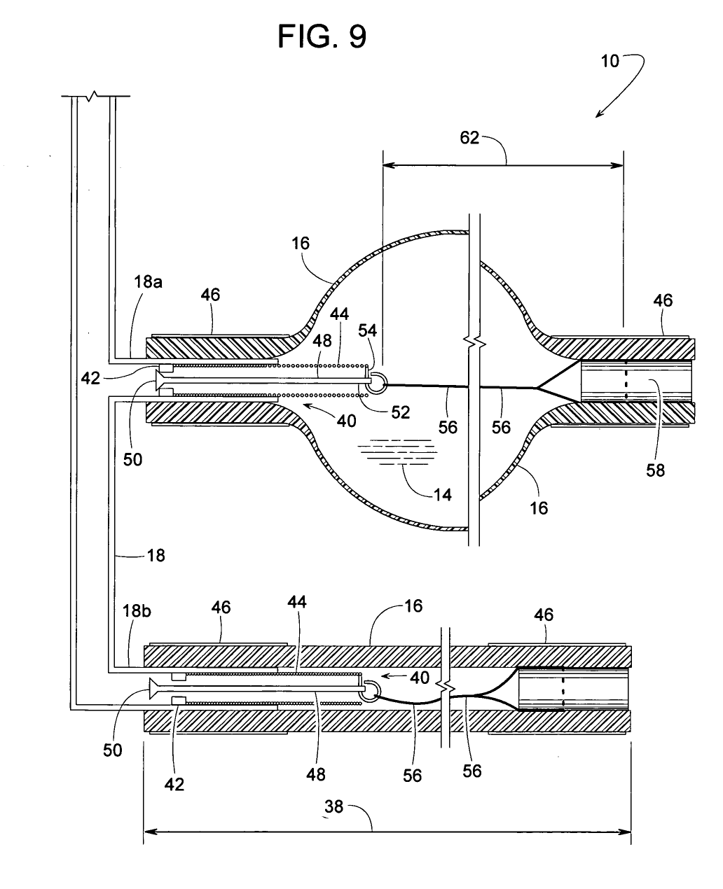

To avoid the impending burst condition and to enable the filling of both bladders 16 through a commonly shared manifold 18, device 10 includes a limit valve 40 that, with respect to fluid flow, is between manifold 18 and each bladder 18. Each limit valve 40 allows the filling of its respective bladder 16; however, once a bladder 16 reaches a predetermined expanded state (FIG. 6 and point 36 of FIG. 8), limit valve 40 automatically closes to prevent overfilling of the limit valve's associated bladder 16. To achieve such function, device 10 and limit valve 40 can be of various designs, such as, for example, the design shown in FIG. 9.

In FIG. 9, manifold 18 includes ends 18a and 18b that are press fitted into the inner diameter of bladders 16. Each bladder assembly includes an annular valve seat 42 preferably made of a polymeric material and a helical tension spring 44 that are press fitted into the inner diameter of ends 18a and 18b. A metal ferrule 46 radially crimped inward helps hold bladders 16, ends 18a and 18b, valve seat 42 and spring 44 in place. A metal screw 48 with a beveled head 50 serves as a valve plug and valve stem, with head 50 being the valve plug and the threaded shank of screw 48 being the valve stem. Head 50 is disposed in proximity with valve seat 42, and a distal end 52 of screw 48 connects to one end 54 of spring 44 such that spring 44 tends to urge head 50 away from valve seat 42, thus limit valve 40 is normally open as shown in FIG. 9.

To close limit valve 40, a flexible and elongate actuator 56 (e.g., string, wire, chain, cable, elastic or inelastic cord, slender rod, slender tube, etcetera, and various combinations thereof) connects screw 48 (via end 54 of spring 44) to an anchor 58 at a back end of bladder 16. In this example, anchor 58 is a neoprene cylindrical plug that is press fitted into an open end of bladder 16 or otherwise affixed bladder 16. A second metal ferrule 46 radially crimped inward can help hold anchor 58 in place and help maintain a tight seal between anchor 58 and bladder 16.

When both bladders 16 are in a relaxed state (FIG. 3 and the lower bladder of FIG. 9 illustrates a bladder in a relaxed state), both limit valves 40 are open and pressurized fluid 14 from manifold 18 can possibly flow into either bladder 16. The bladder 16 having the lowest initial bulge pressure (point 34 of FIG. 8), however, will tend to be the first to expand. For the example of FIG. 9, that happens to be the upper bladder 16. The terms, “upper bladder” and “lower bladder” are in relation to the bladder's location on the drawing figure and are simply used to distinguish between the two substantially equivalent bladders 16. As upper bladder 16 expands beyond its initial bulge volume (FIG. 4) to a greater operating volume (e.g., FIG. 5 or between points 35 and 36 of FIG. 8) the pressure within upper bladder 16 will decrease from its initial bulge pressure (e.g., 25 psig) to a significantly lower normal operating pressure 60 (e.g., 15 psig). The relatively low operating pressure within upper bladder 16 will tend to reduce the pressure within manifold 18, thus the resulting reduced pressure in manifold 18 might be insufficient to cause initial bulging of lower bladder 16. As a result, upper bladder 16 continues to expand, while lower bladder 16 remains at its relaxed state.

As fluid 14 continues to fill upper bladder 16, the upper bladder's lengthwise expansion pulls actuator 56 until actuator 56 reaches its maximum actuator length 62, wherein actuator 56 is in a taut state as shown in the upper bladder of FIG. 9, which corresponds to FIG. 6. In the taut state, actuator 56 stretches spring 44 and pulls head 50 of screw 48 to a closed position against valve seat 42 to obstruct additional fluid 14 from flowing into upper bladder 16 and thus substantially inhibiting bladder 16 from expanding beyond its predetermined expanded state of FIG. 6.

With limit valve 40 of upper bladder 16 closed and lower bladder 16 not yet expanding, the fluid pressure within manifold 18 is free to rise due to lack of flow through manifold 18. Once the fluid pressure in manifold 18 exceeds the initial bulge pressure of lower bladder 16, lower bladder 16 will expand from it relaxed state (FIG. 3), through its initial bulge state (FIG. 4), and to its predetermined expanded state (FIG. 6). When lower bladder 16 reaches its predetermined expanded state, the lower bladder's actuator 56 will pull its limit valve 40 closed to prevent overfilling of the lower bladder 16. At this point, both bladders 16 are full, and both limit valves 40 are closed to prevent overfilling of bladders 16.

To later move each head 50 and valve 40 to the open position and release fluid 14 from within bladders 16, garden nozzle 20 is disconnected from garden hose 30 (or other source of fluid pressure) and garden nozzle 20 is manually opened to release fluid 14 from within manifold 18. As the pressure within manifold 18 becomes less than the pressure within bladders 16, the lengthwise resilience or “springyness” of bladders 16 allows some relative movement between head 50 and seat 42 to release some initial fluid out from within bladders 16. As this initial fluid discharges from device 10, bladders 16 begin retracting, which loosens actuator 56 to a looser state to fully open limit valves 40. In this example of the invention, actuator 56 being in a looser state means that actuator 56 is limp or at least not as stressed as when actuator 56 has limit valve 40 pulled to its closed position. In this example, actuator 56 has a maximum actuator length 62 (FIG. 9) that is greater than the minimum bladder length 38 (FIGS. 3 and 9). Also in this example, limit valve 40 is a fill-and-discharge limit valve that conveys fluid 14 into bladder 16 as bladder 16 goes form its relaxed state (FIG. 3) to its predetermined expanded state (FIG. 6) and discharges fluid 14 from bladder 16 as bladder 16 goes from its predetermined expanded state to its relaxed state.

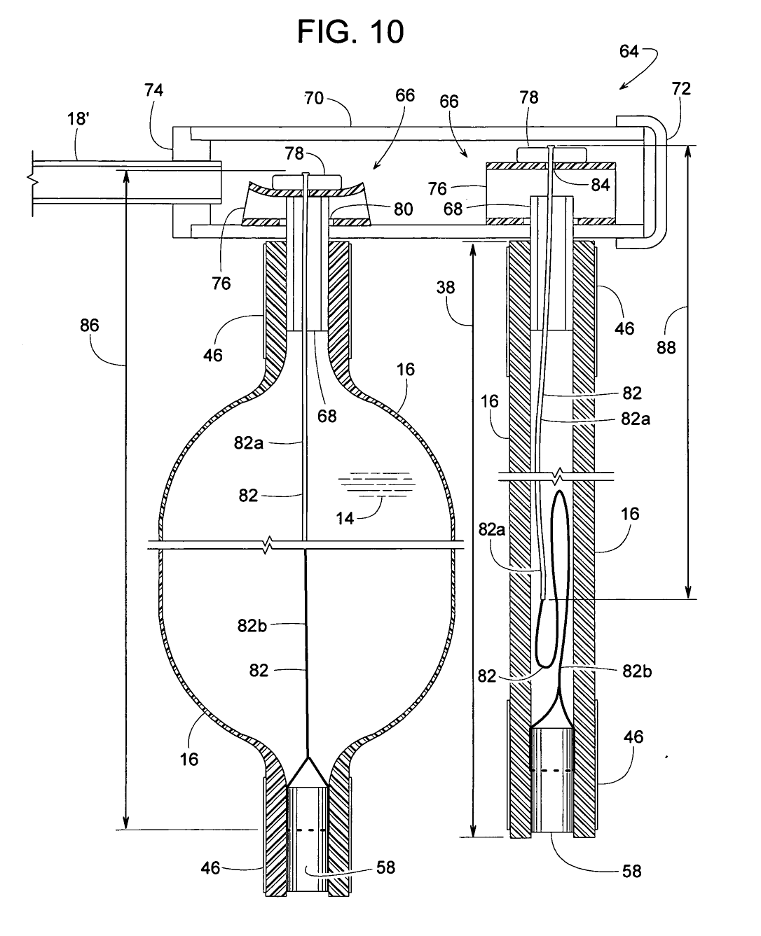

FIG. 10 shows an alternate fluid-handling device 64 with different limit valves 66. Device 64 includes ferrules 46 that help hold anchor 58 and a generally rigid valve tube 68 within opposite ends of each bladder 16. Each valve tube 68 extends through a side hole in a manifold 70 and is bonded, screwed or is otherwise positively attached to a sidewall of manifold 70. Manifold 70 and valve tubes 68 could also be made as a unitary piece. A cap 72 closes off one end of manifold 70, and an adaptor 74 couples the other end of manifold 70 to a tube 18′, which in turn can be connected to conventional garden nozzle 20 in a manner similar to that of device 10. In this example, tube 18′ can be considered as an extension of manifold 70 and is comparable to manifold 18 in that tube 18′ and manifold 18 can both be used to place garden nozzle 20 in fluid communication with bladders 16.

Each limit valve 66 includes a resilient tube 76 and a button 78. Resilient tube 76 has a side hole 80 so that valve tube 68 can protrude upward into the interior of resilient tube 76. The resilience of tube 76 urges limit valve 66 to its open position, as is the case with limit valve 66 at the right side of FIG. 10. Limit valve 66 at the left side of FIG. 10 is closed. Closing limit valve 66 is by way of a flexible elongate actuator 82 (e.g., string, wire, chain, cable, elastic or inelastic cord, slender rod, slender tube, etcetera, and various combinations thereof) that extends through a small hole 84 in resilient tube 76 and connects button 78 to anchor 58.

When both bladders 16 are in a relaxed state (FIG. 3 and the right bladder of FIG. 10 illustrates a bladder in a relaxed state), both limit valves 66 are open and pressurized fluid 14 from tube 18′ and manifold 70 can possibly flow into either bladder 16. The bladder 16 having the lowest initial bulge pressure (point 34 of FIG. 8), however, will tend to be the first to expand. For the example of FIG. 10, that happens to be the left bladder 16. The terms, “right” and “left” are in relation to a part's location on the drawing figure and are simply used to distinguish between two substantially equivalent parts, such as, for example right bladder 16 and left bladder 16. As left bladder 16 expands beyond its initial bulge volume (FIG. 4) to a greater operating volume (e.g., FIG. 5 or between points 35 and 36 of FIG. 8) the pressure within left bladder 16 will decrease from its initial bulge pressure (e.g., 25 psig) to a significantly lower normal operating pressure 60 (e.g., 15 psig). The relatively low operating pressure within left bladder 16 will tend to reduce the pressure within manifold 70, thus the resulting reduced pressure in manifold 70 might be insufficient to cause initial bulging of right bladder 16. As a result, left bladder 16 continues to expand, while right bladder 16 remains at its relaxed state.

As fluid 14 continues to fill left bladder 16, the left bladder's lengthwise expansion pulls left actuator 82 until left actuator 82 reaches its maximum actuator length 86, wherein left actuator 82 is in a taut state as shown in the left bladder of FIG. 10, which corresponds to FIG. 6. In the taut state, left actuator 82 pulls the left button 78 down, which thus clamps the upper sidewall of left resilient tube 76 down against the upper end of left valve tube 68, thereby moving left limit valve 66 to its closed position, as shown on the left side of FIG. 10. Left valve 66 in the closed position with left button 78 and the left resilient tube 76 blocking off left valve tube 68 stops the fluid flow into left bladder 16 and thus prevents left bladder 16 from expanding beyond its predetermined expanded state.

With limit valve 66 of left bladder 16 closed and right bladder 16 not yet expanding, the fluid pressure within manifold 70 is free to rise due to lack of flow through tube 18′ and manifold 70. Once the fluid pressure in manifold 70 exceeds the initial bulge pressure of right bladder 16, right bladder 16 will expand from it relaxed state (FIG. 3), through it initial bulge state (FIG. 4), and to its predetermined expanded state (FIG. 6). When right bladder 16 reaches its predetermined expanded state, the right bladder's actuator 82 will pull the right limit valve 66 closed to prevent overfilling of right bladder 16. At this point, both bladders 16 are full, and both limit valves 66 are closed to prevent overfilling of bladders 16.

To later move each valve 66 to the open position and release fluid 14 from within bladders 16, garden nozzle 20 is disconnected from garden hose 30 (or other source of fluid pressure) and garden nozzle 20 is manually opened to release fluid 14 from within tube 18′ and manifold 70. As the pressure within manifold 70 becomes less than the pressure within bladders 16, the lengthwise resilience or “springyness” of bladders 16 allows some relative movement between button 78 and the upper end of tube 68 to release some initial fluid out from within bladders 16. As this initial fluid discharges from device 64, bladders 16 begin retracting, which loosens actuators 82 to a looser state to fully open limit valves 66. In this example of the invention, actuator 82 being in a looser state means that actuator 82 is limp or at least not as stressed as when actuator 82 has limit valve 66 pulled to its closed position. In this example, actuator 82 has a maximum actuator length 86 (FIG. 10) that is greater than the minimum bladder length 38 (FIGS. 3 and 10). Also in this example, limit valve 66 is a fill-and-discharge limit valve that conveys fluid 14 into bladder 16 as bladder 16 goes form its relaxed state (FIG. 3) to its predetermined expanded state (FIG. 6) and discharges fluid 14 from bladder 16 as bladder 16 goes from its predetermined expanded state to its relaxed state.

Although the actual construction of device 64 may vary, in some examples resilient tube 76 is made of latex rubber; however, other resilient flexible materials would certainly be well within the scope of the invention. Button 78 can be a disc, rectangle or any shape of sufficient size to obstruct the open end of valve tube 68. Button 78 can be made of plastic, metal or any material with sufficient rigidity to prevent actuator 82 from pulling button 78 completely through valve tube 68. As is the case with actuator 56, actuator 82 can be a string, wire, chain, cable, elastic or inelastic cord, slender rod, slender tube, etcetera, and various combinations thereof. For the example illustrated in FIG. 10, actuator 82 includes a stiffer section 82a (e.g., aluminum wire) and a more flexible section 82b (e.g., nylon string) that are joined end-to-end by tying, crimping or any other suitable means. Stiffer section 82a has a stiffer section length 88 that is at least half as long as the relaxed bladder's minimum bladder length 38. This helps prevents fluid discharging from within bladder 16 from flushing the more flexible section 82b of actuator 82 up and out through limit valve 66.

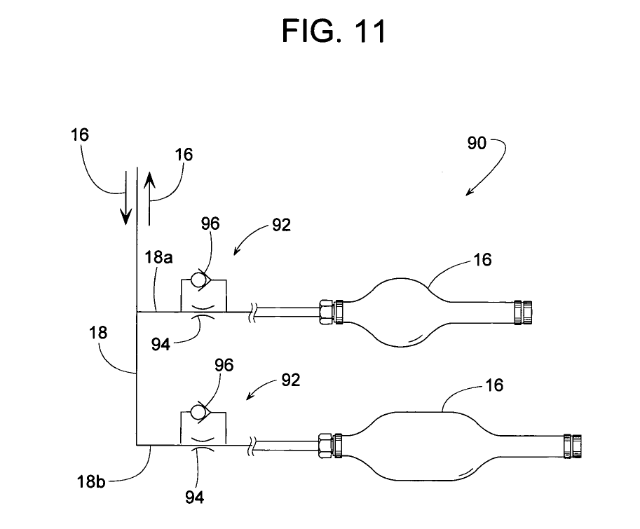

FIG. 11 shows an alternate fluid-handling device 90 comprising upper and lower flow-control valves 92 that connect the upper and lower elastic bladders 16 in fluid communication with manifold 18. Of course, device 90 could be turned sideways in FIG. 11, in which case, valves 92 and bladders 16 would be referred to as right and left components. Each flow-control valve 92 provides an incoming flow restriction 94 to fluid 14 flowing from manifold 18 to bladder 16 and provides an outgoing flow restriction to fluid 14 flowing from elastic bladder 16 to manifold 18. The incoming flow restriction can be provided by an orifice, capillary, needle valve, etc. and is greater than the outgoing flow restriction. The outgoing flow restriction is merely the pipe losses through tubes 18a and 18b and/or the nearly free flow through a check valve 96. The relatively low outgoing flow restriction allows device 90 to spray fluid 14 with minimal flow losses. When filling bladders 16, the higher incoming flow restriction 94 helps maintain the pressure in manifold 18 relatively high upstream of valves 92. Thus, the first bladder 16 to expand will not prevent the other bladder 16 from also reaching its initial bulge pressure.

Although the invention is described with respect to a preferred embodiment, modifications thereto will be apparent to those of ordinary skill in the art. For instance, to improve the connection of adjoining cylindrical parts, it would be well within the scope of the invention to provide cylindrical surfaces of such adjoining parts with conventional barbed ridges. In addition or as an alternative to barbed surfaces, various types of conventional hose clamps can also be used to hold tubular parts together. The number of bladders connected to a common manifold can be one, two, three or any other quantity. To distinguish between similar or identical components, the names of such components can be identified using terms such as, “first,” “second,” “left,” “right,” “upper,” “lower,” etc. The plurality of bladders connected to a common manifold can be substantially equal in size and pressure or the plurality of bladders can differ significantly. The term, “spray nozzle” refers to any fluid discharge device that can release fluid from an elastic bladder and ultimately release the fluid to atmosphere. Examples of a spray nozzle include, but are not limited to, a conventional garden nozzle, a valve, a venturi apparatus, or an eductor cap of a chemical bottle (e.g., U.S. Pat. Nos. 6,578,776; 5,383,603; D451,581 and D358,865). Additional details, background, features and/or advantages of the present invention may be found in U.S. patents issuing from U.S. patent application Ser. Nos. 11/973,167; 11/973,203; and 11/973,166; all of which are specifically incorporated by reference herein. The scope of the invention, therefore, is to be determined by reference to the following claims:

1. A fluid-handling device for discharging a fluid under pressure, the fluid-handling device comprising:
a first elastic bladder that is resiliently expandable;
a second elastic bladder that is resiliently expandable;
a manifold in fluid communication with both the first elastic bladder and the second elastic bladder; and
a spray nozzle connected in fluid communication with the manifold.

2. The fluid-handling device of claim 1, wherein the first elastic bladder is expandable from an initial bulge volume at an initial bulge pressure to a greater operating volume at a normal operating pressure, wherein the initial bulge pressure is greater than the normal operating pressure.

3. The fluid-handling device of claim 1, wherein the first elastic bladder and the second elastic bladder are of substantially equal size when deflated and relaxed.

4. The fluid-handling device of claim 1, further comprising a limit valve that connects the manifold in selective fluid communication with the first elastic bladder, the limit valve has an open position that connects the manifold in fluid communication with the first elastic bladder, the limit valve has a closed position that obstructs fluid communication between the manifold and the first elastic bladder, the first elastic bladder has a relaxed state and a predetermined expanded state, the limit valve is in the open position when the first elastic bladder is in the relaxed state, and the limit valve is in the closed position when the first elastic bladder is in the predetermined expanded state.

5. The fluid-handling device of claim 4, wherein the limit valve moves between the open position and the closed position in response to the first elastic bladder undergoing a predetermined change in length.

6. The fluid-handling device of claim 4, further comprising an actuator that is flexible and elongated, the actuator is operatively coupled to the limit valve and the first elastic bladder so as to pull the limit valve from the open position to the closed position in response to the first elastic bladder undergoing a predetermined change in length.

7. The fluid-handling device of claim 6, wherein the first elastic bladder is expandable from a relaxed state to a predetermined expanded state, the first elastic bladder in the relaxed state has a minimum bladder length, and the actuator has a maximum actuator length that is greater than the minimum bladder length.

8. The fluid-handling device of claim 6, wherein the actuator is disposed within the first elastic bladder and extends between opposite ends of the first elastic bladder.

9. The fluid-handling device of claim 1, further comprising a flow-control valve that connects the first elastic bladder in fluid communication with the manifold, the flow-control valve provides an incoming flow restriction to the fluid flowing from the manifold to the first elastic bladder and provides an outgoing flow restriction to the fluid flowing from the first elastic bladder to the manifold, wherein the incoming flow restriction is greater than the outgoing flow restriction.

10. The fluid-handling device of claim 1, further comprising a backpack in which the first elastic bladder and the second elastic bladder are disposed.

11. The fluid-handling device of claim 1, further comprising:
a spray nozzle; and
a limit valve, wherein the manifold with respect to fluid flow is between the spray nozzle and the limit valve, and the limit valve with respect to fluid flow is between the manifold and the first elastic bladder.

12. A fluid-handling device for discharging a fluid under pressure, the fluid-handling device comprising:
a manifold
a first elastic bladder that is resiliently expandable;
a second elastic bladder that is resiliently expandable;
a first limit valve connecting the first elastic bladder in fluid communication with the manifold; and
a second limit valve connecting the second elastic bladder in fluid communication with the manifold.

13. The fluid-handling device of claim 12, further comprising:
a first actuator that is flexible and elongated, the first actuator is operatively coupled to the first limit valve and the first elastic bladder so as to pull the first limit valve from open to closed in response to the first elastic bladder undergoing a first predetermined change in length; and
a second actuator that is flexible and elongated, the second actuator is operatively coupled to the second limit valve and the second elastic bladder so as to pull the second limit valve from open to closed in response to the second elastic bladder undergoing a second predetermined change in length.

14. The fluid-handling device of claim 13, wherein:
the first elastic bladder is expandable from a first relaxed state to a first predetermined expanded state, the first elastic bladder in the first relaxed state has a first minimum bladder length, the first actuator has a first maximum actuator length that is greater than the first minimum bladder length; and
the second elastic bladder is expandable from a second relaxed state to a second predetermined expanded state, the second elastic bladder in the second relaxed state has a second minimum bladder length, the second actuator has a second maximum actuator length that is greater than the second minimum bladder length.

15. The fluid-handling device of claim 12, further comprising a backpack in which the first elastic bladder and the second elastic bladder are disposed.

16. The fluid-handling device of claim 12, further comprising a spray nozzle connected in fluid communication with the manifold, wherein the manifold with respect to fluid flow is between the spray nozzle and the first limit valve, the manifold with respect to fluid flow is between the spray nozzle and the second limit valve, the first limit valve with respect to fluid flow is between the manifold and the first elastic bladder, and the second limit valve with respect to fluid flow is between the manifold and the second elastic bladder.

17. A fluid-handling device for discharging a fluid under pressure, the fluid-handling device comprising:
a first elastic bladder that is resiliently expandable sequentially from a relaxed state to an initial bulge volume to a predetermined expanded state, the first elastic bladder is at an initial bulge pressure at the initial bulge volume, the first elastic bladder is at a normal operating pressure at the predetermined expanded state, the initial bulge pressure is greater than the normal operating pressure;
a second elastic bladder that is resiliently expandable;
a manifold in fluid communication with both the first elastic bladder and the second elastic bladder;
a limit valve that connects the manifold in selective fluid communication with the first elastic bladder, the limit valve has an open position that connects the manifold in fluid communication with the first elastic bladder, the limit valve has a closed position that obstructs fluid communication between the manifold and the first elastic bladder, the limit valve is in the open position when the first elastic bladder is in the relaxed state, and the limit valve is in the closed position when the first elastic bladder is in the predetermined expanded state; and
an actuator that is flexible and elongated, the actuator is operatively coupled to the limit valve and the first elastic bladder so as to pull the limit valve from the open position to the closed position in response to the first elastic bladder undergoing a predetermined change in length, the first elastic bladder in the relaxed state has a minimum bladder length, and the actuator has a maximum actuator length that is greater than the minimum bladder length.

18. The fluid-handling device of claim 17, wherein the actuator is disposed within the first elastic bladder and extends between opposite ends of the first elastic bladder.

19. The fluid-handling device of claim 17, further comprising a backpack in which the first elastic bladder and the second elastic bladder are disposed.

20. The fluid-handling device of claim 17, further comprising a spray nozzle connected in fluid communication with the manifold, wherein the manifold with respect to fluid flow is between the spray nozzle and the limit valve, and the limit valve with respect to fluid flow is between the manifold and the first elastic bladder.
